(19) United States
(12) Patent Application Publication
(10) Pub. No.: US 2002/0065205 A1
(43) Pub. Date: May 30, 2002

(54) Detergent composition and method for warewashing

(75) Inventors: Antonius Maria Neplenbroek, Maarssen (NL); Bouke Suk, Maarssen (NL)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/973,971

(22) Filed: Oct. 10, 2001

(30) Foreign Application Priority Data
Oct. 10, 2000 (EP) 00203505.3

(51) Int. Cl. C11D 1/00; C11D 3/00

(52) U.S. Cl. 510/220; 510/229

(57) ABSTRACT

The use of an acidic rinse in a mechanical dishwashing process, preferably carried out in an institutional dishwashing machine, for obtaining a soil release effect is provided, whereby a chemical cleaning system for a mechanical warewashing machine is applied, having at least two separate components for aqueous dissolution or dilution to respective use concentrations, a first component comprising a cleaning agent and an alkaline agent for obtaining a neutral or mildly alkaline use concentration, an a second component comprising an acid agent for obtaining an acidic use concentration having a pH of at most 6.0. The first component is introduced into a wash zone or step, and the second component is introduced into a post-wash rinse zone or step.

With this system, highly effective soil removal performance could be obtained even in the absence of any enzyme material.

### FIELD OF THE INVENTION

The present invention relates to cleaning compositions and their use in mechanical warewashing, especially in institutional or industrial, multi-tank or single tank systems having multiple cleaning and rinsing zones or steps.

### BACKGROUND OF THE INVENTION

A conventional multi-tank industrial warewashing machine consists of a conveyor belt system having separate prewash, wash, rinse and drying zones. Fresh wash water is introduced into the rinse zone of the machine and is passed cascade-fashion towards the prewash zone while dishware is transported in a countercurrent direction.

The dishwashing compositions used in such machines generally comprise a cleaning ingredient such as an aqueous solution of a caustic agent (e.g. sodium hydroxide), a sequestering agent such as sodium tripolyphosphate, and a chlorine bleaching agent.

Contact time of the cleaning composition with the dishware is typically quite short, e.g. about 1 minute.

The cleaned dishware is generally rinsed in the final rinse station, using a dilute solution of a rinse aid containing a nonionic surfactant.

One problem which arises in industrial warewashing is the build-up of difficult-to-remove soil, such as starch residues. Starch residues are especially hard to remove when dishware is subjected to high temperatures during food preparation and such foods are left for a long time on heated substrates during distribution.

A proposed solution to this problem is disclosed by EP-A- 282, 214. This document relates to a process for cleaning dirty dishware with a non-directional mist-like spray of a strongly alkaline solution.

Another solution to this problem is provided by WO-94/27488 (Henkel-Ecolab) describing an industrial dishwashing process using a low alkaline detergent and an enzyme dosed into either a rinsing or washing bath of the dishwasher. This publication describes a means of compensating for degradation of the enzyme, particularly an amylase, during standstill phases by adding intermittent doses of the enzyme.

Furthermore, WO-A-96/16152 discloses a cleaning system for a multi-tank mechanical warewashing machine, wherein enzyme and bleach are dosed into different wash tanks or zones of the machine. When applying this last-mentioned cleaning system, good starch and tea-stain removal can be obtained, particularly at moderate enzyme levels.

However, for cost and environmental reasons and—in the case of industrial or institutional mechanical warewashing—for reasons of optimal operator safety, it is often desirable to further reduce the enzyme concentration in cleaning systems for mechanical warewashing.

It is therefore an object of the present invention to provide an effective cleaning system for a—particularly industrial—mechanical warewashing machine, in which limited levels of enzymes or no enzyme material is applied but which gives rise to favourable cleaning performance.

Dishwashing processes involving the application of acid rinse aids have been known in the art. In these known processes, the acid rinse aid is used particularly in order to prevent scaling by water hardness salts present in hard water (by binding such salts) which salts could otherwise lead to blocking of nozzles (see e.g. DE-A-3805881). In these known processes, the acid rinse aid is only used in combination with standard alkaline dishwash detergents. Milder, i.e. less alkaline dishwash detergents clearly have safety benefits, but would generally result in lower cleaning performance, especially leading to starch build-up. This can be partly overcome by using enzymes, particularly amylase enzyme, as has been shown in WO-94/27488. However, these enzymes have limitations such as high cost price and lack of robustness for some soils (e.g. tea-stains)or soil mixtures and conditions (e.g. operation at high temperature, presence of bleach).

We have now surprisingly found that the use of an acid rinse aid can lead to soil release effects, which facilitates the cleaning process. More particularly, we have unexpectedly found that good general cleaning performance can be achieved when applying a chemical cleaning system having a mildly alkaline cleaning component and an acid component, wherein the acid component is dosed into the post-wash rinse zone or step.

### DEFINITION OF THE INVENTION

Accordingly, in a first aspect the present invention provides the use of an acidic rinse solution in a mechanic dishwashing process for obtaining a soil release effect (as defined herein), whereby a chemical cleaning system for a mechanical warewashing machine is applied having at least two separate components for aqueous dissolution or dilution to respective use concentrations, a first component comprising a cleaning agent and an alkaline agent for obtaining a neutral or mildly alkaline use concentration, an a second component comprising an acid agent for obtaining an acidic use concentration having a pH of at most 6.0, preferably at most 4.5,

wherein the first component is introduced into a wash zone or step, and wherein the second component is introduced into a post-wash rinse zone or step.

In a second aspect the invention provides an effective method of warewashing in a mechanical warewashing machine, comprising the steps of:

(1) formulating at least 2 separate components of a chemical cleaning system for aqueous dissolution or dilution to respective use concentrations, a first component comprising a cleaning agent and an alkaline agent for obtaining a neutral or mildly alkaline use concentration, and a second component comprising an acid agent for obtaining an acidic use concentration having a pH of at most 6.0, preferably at most 4.5;

(2) introducing the first component into a wash zone or step to clean dirty dishware;

(3) introducing the second component into a post-wash rinse zone or step to obtain a soil release effect (as defined below),

wherein said method is carried out in a multi-tank or a single-tank institutional mechanical warewashing machine.

Not only the ware washing method of the invention but also the chemical cleaning system used according to the present invention is particularly suitable for use in a multi-tank or a single tank institutional mechanical warewashing machine. Best results were found to be obtainable when using the system and method of the invention in a multi-tank mechanical warewashing machine.

In this connection, a soil release effect is defined as the phenomenon that during a cleaning step the surface of the cleaned dishware is modified to such extent that after the next use and soiling thereof said dishware can be cleaned very effectively.

### DETAILED DESCRIPTION OF THE INVENTION

It was unexpectedly found that with the system of the present invention highly effective soil removal performance could be obtained using a mildly alkaline cleaning component, even in the absence of any enzyme material. Furthermore, even when only an acid agent is present in the -second- component applied in the post-wash rinse zone or step, a remarkable improvement of soil removal performance could be obtained.

It was found that positive soil release effects can generally be obtained with all acid materials. In particular, favourable results could be obtained with citric acid, hydrochloric acid, phosphoric acid and sorbic acid.

Preferably, the level of the acid used in the second component is such that the pH of the use concentration thereof (i.e. the concentration applied in the post-wash rinse zone or step) is in the range of from 1-4.5, more preferably from 2.5-3.5. Generally, the concentration of the acid in the second -rinse aid- component for obtaining such pH-value at use concentration, is in the range of from 5 to 50% by weight. To obtain the correct acidity in the post-wash rinse zone or step, deionised water is preferably used for diluting the second component to use concentration.

Other ingredients having a rinse aid function, such as specific nonionic surfactants, may be present in the acidic second component. It was found that these other components do not have a significant influence on the positive effects of the acid present.

For instance, similar positive soil release effects were obtained when dishware was previously rinsed with an acidic solution having a pH of 3 and only containing an acid agent, as with a similar acidic solution also having a pH of 3 but containing a nonionic surfactant, as rinse aid, in addition to the acid agent.

Both oxygen-based and halogen-based (particularly chlorine-based) bleach compounds could generally be contained in the second component, for enhancing the cleaning performance of the system of the invention.

Furthermore, hydrogen peroxide is preferably an ingredient of the second component, since it was found that in that case the total cleaning and bleaching efficiency of the system of the invention is improved.

The positive soil release effects found were most pronounced when ceramic dishware was treated.

In addition to the improved cleaning and disinfection performance obtained as a result thereof, the system and process of the invention may also lead to the following additional advantages:

less detergent product is needed for cleaning. In some cases, cleaning with only water was found to be already sufficient; and/or

less aggressive materials are needed for cleaning; and/or

less water and energy (temperature) are needed for cleaning; and/or

less cleaning time is needed.

As a consequence, the system of the present invention not only leads to improved cleaning performance but also has a possible cost-saving effect.

Typical aqueous dissolution or dilution rates for the first component of the system of the present invention is such that the weight of the component per unit volume of water is in the range of from 0.5 to 5 g/l, preferably from 1 to 4 g/l.

For the second component, typical aqueous dissolution or dilution rates are such that the weight of the component per unit volume of water is in the range of from 0.1 to 2 g/l, preferably 0.2 to 1 g/l.

The First Component

The first component contains an alkaline agent and a cleaning agent.

Suitable alkaline agents include alkali metal hydroxides, e.g. sodium or potassium hydroxide, and alkali metal silicates, e.g. sodium metasilicate. The level of alkaline agent present in the first component is preferably such that the pH of the use concentration thereof (i.e. the pH applied in the wash zone or step into which the first component is introduced) is in the range of from 6 to 11, more preferably from 8 to 10.5.

When sodium hydroxide is applied as alkaline agent, its concentration in the first component is generally less than 2% wt. On the other hand, the concentration of sodium metasilicate in the first component may be up to 10% wt.

The cleaning agent content of the first component may include one or more agents selected from builders (i.e. detergency builders including the class of chelating agents/sequestering agents), bleaches, enzymes and surfactants.

Suitable builder materials (phosphates and non-phosphate builder materials) are well-known in the art and many types of organic and inorganic compounds have been described in the literature. They are normally used in all sorts of cleaning compositions to provide alkalinity and buffering capacity, prevent flocculation, maintain ionic strength, extract metals from soils and/or remove alkaline earth metal ions from washing solutions.

The builder materials usable herein can be any one or mixtures of the various known phosphate and non-phosphate builder materials. Examples of suitable non-phosphate builder materials are the alkali metal citrates, carbonates and bicarbonates; and the salts of nitrilotriacetic acid (NTA); methylglycine diacetic acid (MGDA); serine diacetic acid (SDA); imino disuccinic acid (IDS); dipicolinic acid (DPA); oxydisuccinic acid (ODS); alkyl and alkenyl succinates (AKS); ethylenediamine tetraacetates, oxidized heteropolymeric polysaccharides, polycarboxylates such as polymaleates, polyacetates, polyhydroxyacrylates, polyacrylate/polymaleate and polyacrylate/polymethacrylate copolymers and the terpolymer of polyacrylate/polymaleate and vinylacetate (ex Huls), as well as zeolites; layered silicas and mixtures thereof. They may be present in the first component, in the range of from 1 to 90% by weight, and preferably from 5 to 60%wt, more preferably from 10 to 40%wt.

Particularly preferred builders are phosphates, citrates, DPA, ODS, alkenyl succinates, carbonates, bicarbonates, the higher molecular weight block copolymers ITA/VA having MW greater than 60,000, maleic anhydride/(meth) acrylic acid copolymers, e.g. Sokalan CP5 ex BASF; NTA and terpolymers, polyacrylate/polymaleate and vinyl acetate (supplied by Huls).

Scale formation on dishes and machine parts are an important problem that needs to be resolved or at least mitigated in formulating a machine warewashing product, especially in the case of low-phosphate (e.g. less than the equivalent of 20% by weight of sodium triphosphate) and phosphate-free machine warewashing compositions, particularly zero-P machine warewashing.

In order to reduce this problem, co-builders, such as polyacrylic acids or polyacrylates (PAA), and the various organic polyphosphonates, e.g. of the Dequest range, may be incorporated in the first component. For improved biodegradability, co-builders, such as the block copolymers of formula (I) as defined in WO-A-94/17170 may also be used. The amount of co-builder present in the first component may be in the range of from 0.5 to 10%, preferably from 0.5 to 5%, and more preferably from 1 to 5% by weight.

Further, the first component may comprise one or more surfactants. Surfactants may also be present , as rinse aid, in the second component. In the first component, the surfactants may be present in a range up to 20%, preferably from 0.1 to 15%, and more preferably from 0.5 to 10% by weight.

Normally, in a properly built or highly built composition as is conventional, only small amounts of low- to non-foaming nonionic surfactant are present, to aid detergency and particularly to suppress excessive foaming caused by some protein soil. Higher amounts of highly detersive surfactants, such as the high HLB nonionic surfactants, the anionic sulphate or sulphonate surfactants and the alkyl polyglycoside class of surfactants, may be used in low builder-containing active/enzyme-based compositions.

The composition of the first component may also include a defoamer. Suitable defoamers include mono—and distearyl acid phosphates, silicone oils, mineral oils, and organic carriers containing long-chain ketones (e.g. the Dehypon series, ex Henkel KGaA, Germany). The composition may include 0.02 to 2% by weight of a defoamer, or preferably 0.05 to 1.0% by weight.

Bleaching Agent

Suitable bleaches for use in the first component of the system of the present invention may generally be halogen-based bleaches or oxygen-based bleaches. However, oxygen-based bleaches are preferred.

If no enzyme material is present in the system of the invention, a halogen-based bleach may be effectively used as ingredient of the first component. In that case, saoid bleach is desirably present at a concentration (as active halogen) in the range of from 0.1 to 10%, preferably from 0.5 to 8%, more preferably from 1 to 6%, by weight. As halogen bleach, alkali metal hypochlorite may be used. Other suitable halogen bleaches are alkali metal salts of di- and tri-chloro and di- and tri-bromo cyanuric acids.

Suitable oxygen-based bleaches are the peroxygen bleaches, such as sodium perborate (tetra-or monohydrate), sodium percarbonate or hydrogen peroxide. These are preferably used in conjunction with a bleach activator which allows the liberation of active oxygen species at a lower temperature. Numerous examples of activators of this type, often also referred to as bleach precursors, are known in the art and amply described in the literature such as U.S. Pat. No. 3,332,882 and U.S. Pat. No. 4,128,494 herein incorporated by reference. Preferred bleach activators are tetraacetyl ethylene diamine (TAED), sodium nonanoyloxybenzene sulphonate (SNOBS), glucose pentaacetate (GPA), tetraacetylmethylene diamine (TAMD), triacetyl cyanurate, sodium sulphonyl ethyl carbonic acid ester, sodium acetyloxybenzene and the mono long-chain acyl tetraacetyl glucoses as disclosed in WO-91/10719, but other activators, such as choline sulphophenyl carbonate (CSPC), as disclosed in U.S. Pat. No. 4,751,015 and U.S. Pat. No. 4,818,426 can also be used.

Peroxybenzoic acid precursors are known in the art as described in GB-A-836,988, herein incorporated by reference. Examples of suitable precursors are phenylbenzoate, phenyl p-nitrobenzoate, o-nitrophenyl benzoate, o-carboxyphenyl benzoate, p-bromophenyl benzoate, sodium or potassium benzoyloxy benzene sulfonate and benzoic anhydride.

Preferred peroxygen bleach precursors are sodium p-benzoyloxy-benzene sulfonate, N,N,N,N-tetraacetyl ethylene diamine (TEAD), sodium nonanoyloxybenzene sulfonate (SNOBS) and choline sulfophenyl carbonate (CSPC).

The amounts of sodium perborate or percarbonate and bleach activator in the first component preferably do not exceed 30% respectively 10% by weight, e.g. are in the range of from 4-30% and from 2-10% by weight, respectively.

Furthermore, organic peroxyacids may be effectively used as bleach material in the first component of the system of the invention. Such materials normally have the general formula:

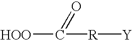

wherein R is an alkylene or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a COOH, or a

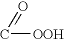

group or a quaternary ammonium group.

Typical monoperoxy acids useful herein include, for example:

(i) peroxybenzoic acids and rin-substituted peroxybenzoic acids, e.g. peroxy-alpha-naphthoic acid;

(ii) aliphatic, substituted aliphatic and arylalkyl monoperoxyacids, e.g. peroxylauric acid, peroxy-atearic acid and N,N-phthaloylaminoperoxy caproic acid (PAP); and

(iii) 6-octylamino-6-oxo-peroxyhexanoic acid.

Typical diperoxyacids useful herein include, for example:

(i) 1,12-diperoxydodecanedioic acid (DPDA);

(ii) 1,9-diperoxyazelaic acid;

(iii) diperoxy brassilic acid, diperoxysebasic acid and diperoxyisophthalic acid; and

(iv) 2-decyldiperoxybutane-1,4-doitic acid.

Also inorganic peroxyacid compounds, such as for example potassium monopersulphate (MPS), are suitable for use in the first component of the system of the present invention. All these peroxy compounds may be utilized alone ort in conjunction with a bleach precursor as described above. If present, the concentration of the peroxyacid in the first component of the system of the invention is suitably 0.1-20%, preferably 0.5-15%, more preferably 1-10% by weight.

Enzymatic Material

Preferably, an enzyme is present the first component of the system of the invention. Amylolytic and/or proteolytic enzymes would normally be used, the amylolytic enzymes being preferred.

The amylolytic enzymes usable herein can be those derived from bacteria or fungi. Preferred amylolytic enzymes are those prepared and described in GB Patent No. 1,296,839 cultivated from the strains of Bacillus licheniformis NCIB 8061, NCIB 8059, ATCC 6334, ATCC 6598, ATCC 11945, ATCC 8480 and ATCC 9945 A. An example of such amylolytic enzymes is the amylase produced and distributed under the tradename Termamyl by Novo Industri A/S, Copenhagen Denmark. Other suitable types of amylases because of their oxidation stability are Duramyl (ex Novo) and Purafect OxAm (ex Genencor).

These amylolytic enzymes are generally presented as granules or liquids. They may be present in the first component of the system of the invention in amounts such that the final use composition of said component has amylolytic enzyme activity of from 10 to 10⁸ Matose

Units/kilogram, preferably from 10² to 10⁶ MU/kg, and more preferably from 10² to 10⁴ MU/kg.

The amylolytic activity as referred to herein can be determined by the method as described by P. Bernfeld in “Method of Enzymology”, Volume I (1955), page 149.

The proteolytic enzymes usable herein, for instance, the subtilisins which are obtained from particular strains of B. subtilis and B. Licheniformis, such as the commercially available subtilisins maxatase, supplied by Gist-Brocades N.V., Delft, Holland, and Alcalase, supplied by Novo Industri A/S, Copenhagen, Denmark. Particularly suitable are proteases obtained from a strain of bacillus having maximum activity throught the pH range of 8-12, being commercially available from NOVO Industri A/S under the tradenames of Esperase and Savinase. The preparation of these and analogous enzymes is described in GB Patent No. 1,243,784. These enzymes are generally presented as granules, e.g. marumes, prills, T-granulates, etc., or liquids and may have enzyme activity of from 500 to 6,000 Glycine Units/mg.

The proteolytic enzyme activity can be determined by the method as described by M.L. Anson in “Journal of General Physiology”, Vol. 22 (1938), page 79 (one Anson unit/gram=733 Glycine Units/milligram).

In the compositions of the invention, proteolytic enzymes may be present in amounts such that the final use composition of the first component has proteolytic enzyme activity of from about 10 to 10¹⁰ Glycine Units/kilogram, preferably from 10² to 10¹⁰ and more preferably from 10⁴ to 10⁹.

Other enzymes, such as lipolytic enzymes, may also be incorporated to improve fat removal. Typical examples of commercial lipolytic enzymes are Lipase YL, Amano CE, Wallerstein AW, Lipase My, and Lipolase ex Novo Industries.

Other Ingredients

Minor amount of various other ingredients may be present in the chemical cleaning system of the invention. These ingredients include bleach scavengers, anti-foaming agents, solvents, and hydrotropes such as ethanol, isopropanol and xylene sulphonates, flow control agents; enzyme stabilizing agents; soil suspending agents; anti-redeposition agents; anti-tarnish agents; anti-corrosion agents; colorants and other functional additives.

Components of the present invention may independently be formulated in the form of solids (optionally to be dissolved before use), aqueous liquids or non-aqueous liquids (optionally to be diluted before use).

The Warewashing Process

The inventive chemical cleaning system may be generally utilized in any of the conventional, domestic and institutional, warewashing machines.

However, as mentioned above, both the cleaning system and the warewashing method of the present invention are particularly suitable for use in an institutional mechanical warewashing machine.

Typical institutional warewashing processes are either continuous or non-continuous and are conducted in either a single-tank or a multi-tank/conveyor-type machine.

In the conveyor-type system prewash, wash, post-wash rinse and drying zones are generally established using partitions. Wash water is introduced into the post-wash rinsing zone and is passed cascade-fashion back toward the prewash zone while the dirty dishware is transported in a counter-current direction. In an alternative (socalled “by-pass”) process, this rinse-water is introduced into the pre-wash zone. It may be attractive to combine this “by-pass” process with the method of the present invention, because in this way a pH-gradient is created over the wash tanks, which is likely to lead to more optimal conditions for soil removal. For instance, enzymes—when present in the first component—can become more active at the more neutral pH-conditions resulting from the introduction of acid post-wash rinse composition into the prewash zone. Various multi-tank warewashing machines have the option to rinse only when dishes are passed through the post-wash rinsing section. It can be attractive to combine this option with the method of the present invention, because in that way the volume of the acid rinse solution is limited. Such limited acid rinse volume will only have a limited effect as to its ability to reduce the alkalinity of the main wash solution.

Furthermore, each component of the cleaning system of the invention is applied in the warewashing machine using conventional means such as suitable spray nozzles or jets directed upwards and/or downwards toward the dishware.

The present invention will now be further illustrated by way of the following non-limiting examples, in which parts and percentages are by weight unless otherwise indicated.

### EXAMPLE 1

In this example, the soil release effect of pretreatment of ceramic dishes with an acid rinse product was evaluated. The following test procedure was applied.

An acid solution of citric acid in water having a pH of 3.5, was prepared by dissolving citric acid in water and heating this solution to 60° C.

Ceramic dishes were immersed half in this acid solution, for a time period of 30 seconds.

Subsequently, said ceramic dishes were rinsed with water and dried. Then, the dishes were soiled entirely with roux after which they were aged at 115° C. for 1 hr.

The roux-mixture used for soiling the dishes was prepared by dissolving 1% wt potatoe starch (ex Honig) and 5% wt Roux Blanc (ex Nestlé Foodservices) in 94% wt de-ionised water.

Thereafter, the soiled dishes were cleaned in a single tank machine using, as a cleaning agent, either soft water (having a pH of 7) or soft water containing 1% wt NaCl. This cleaning step was carried out by washing the dishes at 55-65° C. for 80 seconds using the indicated cleaning agent, and subsequently rinsing the washed dishes with hot water (80-90° C.) for 20 seconds.

Subsequently, the level of starch remaining on said dishes after this cleaning step was evaluated, using iodine to visualize the remaining starch.

By comparing the half of the dishes which had been immersed in the acid solution of citric acid with the half which had not been immersed, conclusions could be drawn about the effect of pretreating the dishes with the acid solution. The results obtained are shown below, in Table 1.

TABLE 1

| | half, not pretreated | half, pretreated |
|---|---|---|
| Cleaning agent | (% clean) | (% clean) |
| water | 10% | 20% |
| water + 1% NaCl | 25% | 55% |

These results clearly show that even in the absence of real cleaning chemicals, soil release effects can be obtained by pretreating ceramic dishes in an acid solution of citric acid in water.

### EXAMPLE 2

In this example, the soil release effect on ceramic dishes when applying various rinse aid compositions in addition to a low alkaline cleaning agent, was evaluated after several soiling/cleaning cycli.

The following test procedure was applied. Ceramic dishes were first pre-rinsed with one of the rinse solutions described below and used further-on in the specific test concerned.

Thereafter, these dishes were soiled entirely by spraying on a roux mixture as specified in Example 1 after which the thus-obtained soiled dishes were dried for about 2-3 minutes at a temperature increasing from 25 to 75° C.

Subsequently, the soiled dishes were cleaned (during ca. 2 minutes) and rinsed (for about 10 seconds) in a multi-tank machine having a washing zone and a rinsing zone.

In the washing zone, a mildly alkaline cleaning solution with a pH of 10 was applied, said solution containing de- ionised water and a cleaning agent dosed therein at a concentration of 1 g/liter water. This cleaning agent has the following composition:

| | (% wt) |
|---|---|
| sodium tripolyphosphate | 63 |
| sodium metasilicate 5 aq. | 17 |
| sodium carbonate | 15 |
| chlorine | 5 |

In the rinse zone, three different rinse aids were applied, dosed at a concentration of 1 g/liter water for obtaining a rinse solution and having the following compositions:

| | I | II | III |
|---|---|---|---|
| rinse aid | (% wt) | (% wt) | (% wt) |
| wetting nonionics | 5 | 5 | 5 |
| anti-foaming nonionics | 5 | 5 | 5 |
| citric acid | 0 | 10 | 40 |
| water | 90 | 80 | 50 |

The pH-values of the rinse solutions prepared with these rinse aids are 7 (for rinse aid I), 4 (for rinse aid II), respectively 3 (for rinse aid III).

After treating the ceramic dishes with the above cleaning and rinsing solutions, the dishes were soiled again.

The effect of the acidity of the rinse solution on starch build-up on the treated dishes was measured and evaluated after 10 soiling/cleaning cycli.

The results (in terms of the cleanliness after 10 cycli) are shown below.

| | | Effect obtained (% clean) |
|---|---|---|
| Rinse aid I | (pH = 7) | 20 |
| Rinse aid II | (pH = 4) | 42 |
| Rinse aid III | (pH = 3) | 78 |

Considering these results, it can be concluded that the significant starch build-up resulting from the use of a mildly alkaline cleaning agent can be prevented by the soil release effects of using an acid rinse solution having considerable levels of citric acid.

1. Method of use of an acidic rinse solution in a mechanical dishwashing process for obtaining a soil release effect (as defined herein),
whereby a chemical cleaning system for a mechanical warewashing machine is applied having at least two separate components for aqueous dissolution or dilution to respective use concentrations, a first component comprising a cleaning agent and an alkaline agent for obtaining a neutral or mildly alkaline use concentration, an a second component comprising an acid agent for obtaining an acidic use concentration having a pH of at most 6.0,
wherein the first component is introduced into a wash zone or step, and wherein the second component is introduced into a post-wash rinse zone or step.

2. The method of use according to claim 1, wherein the acidic use concentration obtainable from the second component has a pH of at most 4.5.

3. The method of use according to claim 1, wherein the system is applied in a multi-tank or a single-tank, institutional mechanical warewashing machine.

4. The method of use according to claim 1, wherein the use concentration obtainable from the first component has a pH in the range of from 6 to 11, preferably from 8 to 10.5.

5. The method of use according to claim 1, wherein the use concentration obtainable from the second component has a pH in the range of from 1 to 4.5, preferably from 2.5 to 3.5.

6. The method of use according to claim 1, wherein the first component comprises an enzyme.

7. The method of use according to claim 6, wherein the enzyme is amylase.

8. A method of warewashing in a mechanical warewashing machine, comprising the steps of:
(1) formulating at least 2 separate components of a chemical cleaning system for aqueous dissolution or dilution to respective use concentrations, a first component comprising a cleaning agent and an alkaline agent for obtaining a neutral or mildly alkaline use concentration, and a second component comprising an acid agent for obtaining an acidic use concentration having a pH of at most 6.0;
(2) introducing the first component into a wash zone or step to clean dirty dishware;
(3) introducing the second component into a post-wash rinse zone or step to obtain a soil release effect (as defined below),
wherein said method is carried out in a multi-tank or a single-tank institutional mechanical warewashing machine.

9. Method according to claim 8, wherein the acidic use concentration obtainable from the second component has a pH of at most 4.5.

10. Method according to claim 8, wherein said method is carried out in a multi-tank institutional mechanical warewashing machine.

11. The method according to claim 8, wherein the treated dishware is made of ceramic material.
